(19) United States
(12) Patent Application Publication
(10) Pub. No.: US 2007/0045981 A1
(43) Pub. Date: Mar. 1, 2007

(54) Vehicle suspension side sill assembly

(76) Inventors: Greg T. Galazin, Muskegon, MI (US); Cameron J. Swanson, Twin Lakes, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/501,944

(22) Filed: Aug. 10, 2006

Related U.S. Application Data
(60) Provisional application No. 60/707,087, filed on Aug. 10, 2005.

(51) Int. Cl. B62D 53/06; B62D 21/00

(52) U.S. Cl. 280/149.2; 280/781

(57) ABSTRACT

A slider assembly includes a pair of longitudinally-extending slider members adapted to slidably couple to a pair of longitudinally-extending rail members of a vehicle frame assembly, each slider member including a top wall, a bottom wall and at least one lip portion extending longitudinally along and inwardly from at least a select one of the top wall and the bottom wall, wherein the at least one lip portion includes a notch extending therein. The slider assembly further includes at least one cross member having a pair of opposite ends and extending between the slider members, wherein the ends of the at least one cross member are located within the at least one notch of the slider members, such that the cross member is located proximate the top and bottom walls of each of the slider members.

### CROSS REFERENCE TO RELATED APPLICATION

This application claims the benefit of U.S. Provisional Application No. 60/707,087, filed Aug. 10, 2005, entitled VEHICLE SUSPENSION SIDE SILL ASSEMBLY, which is hereby incorporated herein by reference in its entirety.

### BACKGROUND OF THE INVENTION

The present invention relates generally to a vehicle suspension assembly, and in particular to a vehicle suspension side sill assembly for adjustment of a vehicle suspension longitudinally with respect to a body of the vehicle.

Conventional sliders used for the purposes of enabling the adjustment of a vehicle suspension system of a tandem axle trailer longitudinally with respect to a vehicle frame assembly typically comprise a pair of side rails secured at the left and right sides of the vehicle frame assembly, and a subframe having a pair of slide members slidably coupled with the vehicle frame assembly. Typically, a plurality of locking pins lock the subframe assembly in various positions of adjustment relative to the side rails of the frame assembly, wherein the locking pins are retractable for permitting adjustment of the subframe assembly to a selected position of adjustment and extensible for locking the subframe assembly in the selected position of adjustment. The subframe assemblies typically also include laterally-extending structural reinforcement members coupled to the slide members so as to form and reinforce the subframe assembly.

The slide members of the subframe assemblies of common conventional sliders are typically inwardly-facing and C-shaped, and include top and bottom surfaces and upwardly and/or downwardly-turned edge portions extending along the top and bottom surfaces. The laterally-extending structural members utilized with these rail members are typically provided with a vertical height that allows the ends of the structural members to be received within the associated rail members and between the top and bottom surfaces thereof. The position of the ends of the structural members with respect to each associated slide rail is determined by premeasuring the location thereof prior to welding the ends of the structural members to the slide rails. The location of the structural members with respect to the slide rails must be precisely met so as to provide the proper and necessary structural support, as well as to prevent binding of the slide rails with respect to the frame rails of vehicle frame. Further, the structural integrity of the subassembly, which undergoes significant sheering and torsional stress during operation of the vehicle, is limited by the overall vertical height or thickness of the structural members.

A vehicle suspension slider assembly is required that allows positive and precise positioning of structural cross members with respect to the associated slide members of a subframe assembly of a vehicle slider assembly, while simultaneously increasing the structural strength and rigidity thereof.

### SUMMARY OF THE INVENTION

The present invention relates to a vehicle assembly that comprises a pair of longitudinally-extending rail members, and a slider assembly including a pair of longitudinally-extending slider members slidably coupled to the rail members and each having a top wall, a bottom wall, and at least a lip portion extending longitudinally along and inwardly from at least a select one of the top wall and the bottom wall. The slider assembly further includes at least one cross member extending between the slider members, wherein the at least one lip portion of each of the slider members includes a notch that receives an end of the at least one cross member therein, such that the slider member is located proximate the top and bottom walls of each of the slider members. The vehicle assembly further includes a locking assembly operably coupled to the slider assembly and adapted to releasably engage the rail members, thereby selectively positioning the slider assembly with respect to the rail members, and a suspension assembly operably coupled to the slider assembly, thereby supporting the slider assembly and the rail members above the ground surface.

The present invention further relates to a slider assembly for adjustably supporting a vehicle frame assembly from a vehicle suspension assembly, the slider assembly comprising a pair of longitudinally-extending slider members adapted to slidably couple to a pair of longitudinally-extending rail members of a vehicle frame assembly, wherein each slider member includes a top wall, a bottom wall, and at least one lip portion extending longitudinally along and inwardly from at least a select one of the top wall and the bottom wall, and wherein the at least one lip portion includes a notch extending therein. The slider assembly also includes at least one cross member having a pair of opposite ends and extending between the slider members, wherein the ends of the at least one cross member are located within the at least one notch of the slider members, such that the cross member is located proximate the top and bottom walls of each of the slider members.

The present inventive slider assembly provides positive and precise positioning of structural cross members with respect to the associated slide members of a subframe assembly of a vehicle slider assembly, while simultaneously increasing the structural strength and rigidity thereof. Further, the slider assembly is more durable, efficient in use, economical to manufacture, is capable of a long operating life, and is particularly well adapted for the proposed use.

### BRIEF DESCRIPTION OF THE DRAWINGS

FIG. 1 is a perspective view of a slider assembly embodying the present invention, and a pair of frame rails of an associated trailer or vehicle;

FIG. 2 is a perspective view of a first embodiment of a slider member of the slider assembly;

FIG. 3A is an end view of a second embodiment of one of the slider members;

FIG. 3B is an end view of a third embodiment of one of the slider members;

FIG. 3C is an end view of a fourth embodiment of one of the slider members;

FIG. 3D is an end view of a fifth embodiment of one of the slider members;

FIG. 4 is a partial perspective view of one of the slider members;

FIG. 5 is a partial perspective view of a first end of a cross member coupled to a first slider member; and

FIG. 6 is a partial perspective view of a second end of the cross member coupled to a second slider member.

### DETAILED DESCRIPTION OF THE PREFERRED EMBODIMENTS

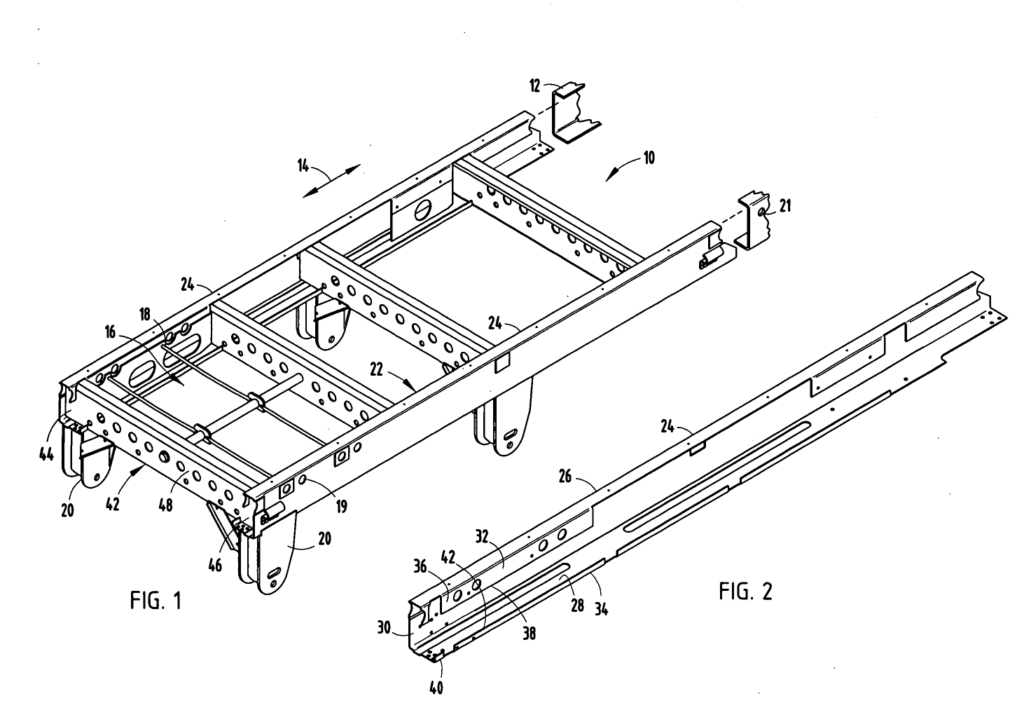

For purposes of description herein, the terms “upper, ” “lower, ” “right, ” “left, ” “rear, ” “front, ” “vertical, ” “horizontal, ” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 10 (FIG. 1) generally represents a slider assembly embodying the present invention. The slider assembly 10 is slidably mounting within and between a pair of vehicle frame rails 12 in a manner as known in the art. In the illustrated example, the frame rails 12 are each provided with a C-shaped, cross-sectional configuration and are inwardly opening towards one another. The slider assembly 10 is slidably disposed between the frame rails 12 for translation in a direction as indicated and represented by directional arrow 14. The position of the slider assembly 10 with respect to the frame rails 12 is selectively fixed by a locking assembly 16. In the illustrated example, the locking assembly 16 includes a plurality of spring-biased locking pins 18 that engage apertures 19 in both the slider assembly 10 and apertures 21 and the frame rails 12 as is known in the art. A plurality of downwardly-extending mounting brackets 20 are utilized to pivotally support a suspension assembly below the slider assembly 10. It is contemplated that the suspension assembly includes a trailing arm-tight suspension, however, other suspension arrangements and assemblies may be utilized as appropriate for a particular application.

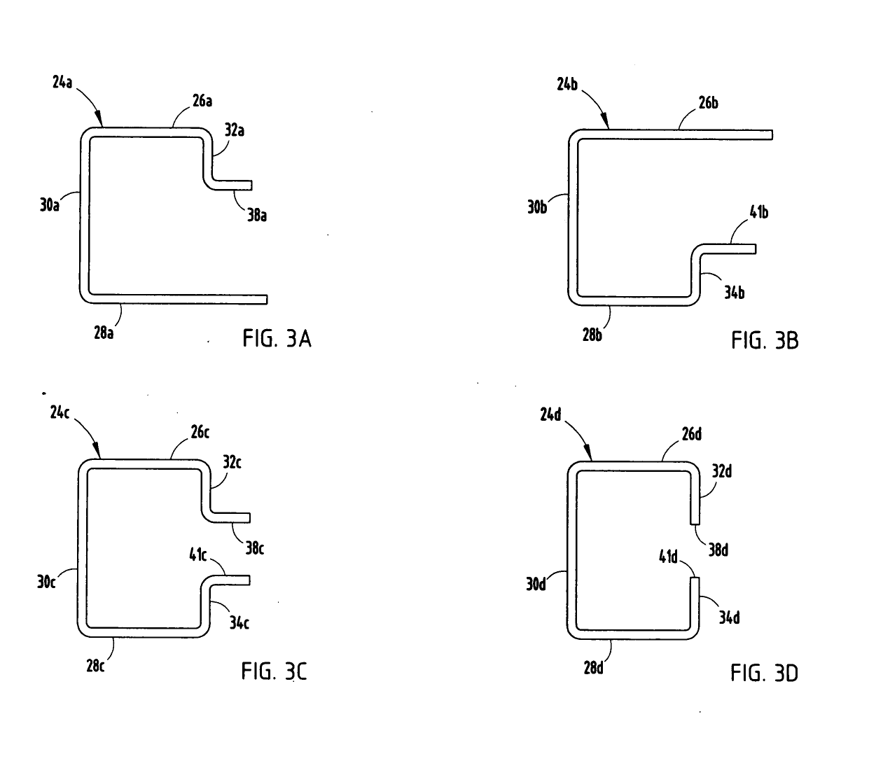

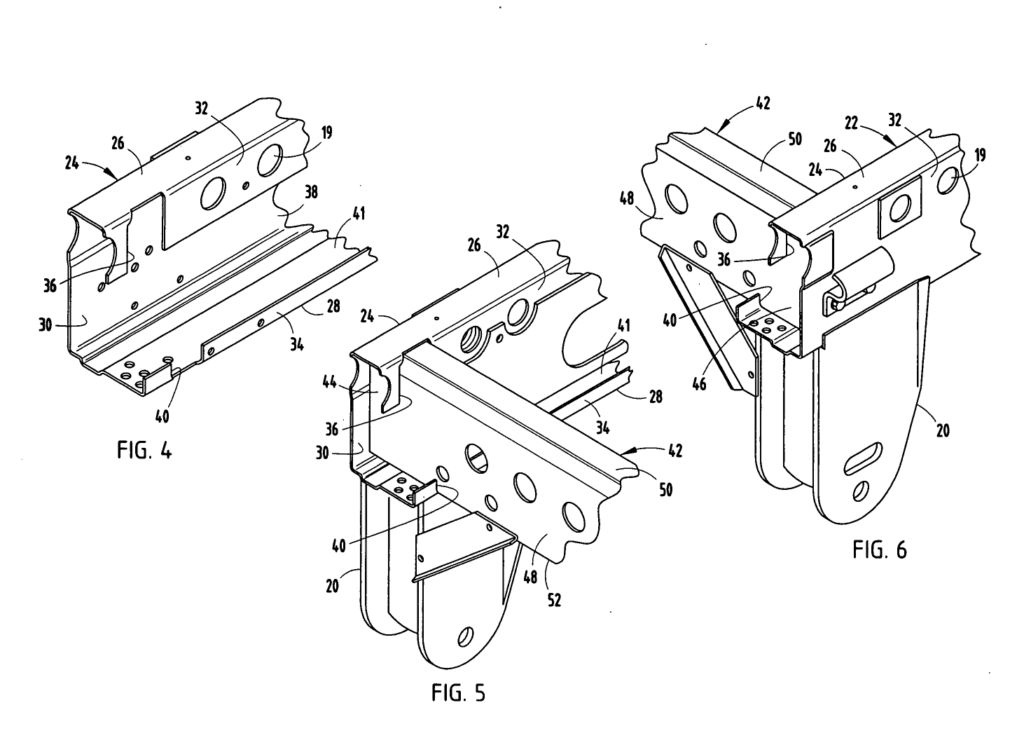

The slider assembly 10 includes a subframe assembly 22 having a pair of longitudinally-extending slider members 24 (FIG. 2) each having a C-shaped cross-sectional configuration and including a top wall 26, a bottom wall 28 spaced apart from the top wall 26 and extending parallel thereto, and an outer wall 30 extending between and integrally formed with the top wall 26 and the bottom wall 28. Each slider member 24 further includes a top lip portion 32 extending orthogonally downwardly from and integrally formed with the top wall 26 juxtapositioned from the outer wall 30 across the top wall 26. Each slider member 24 further includes a bottom lip portion 34 extending orthogonally upwardly from and integrally formed with the bottom wall 28 juxtaposed across the bottom wall 28 from the outer wall 30. In the illustrated example, each slider member 24 is provided with a C-shaped cross-sectional configuration, with the bottom lip portion 34 being inwardly offset from the top lip portion 32, however, numerous cross-sectional configurations that provide a top lip portion 32 and/or a bottom lip portion 34, as illustrated in FIGS. 3A-3D, may be substituted therefore depending upon the particulars of the application. Since the alternative embodiments of the slider members 24a, 24b, 24c, 24d are each similar to the slider members 24, similar parts appearing in FIG. 2 and FIGS. 3A-3D are represented by the same, corresponding reference numeral, except for the suffix “a, ” “b, ” “c ” and “d, ” respectively, in the numerals of the latter. The top lip portion 32 (FIG. 4) of each slider member 24 is provided with a plurality of notches 36 extending from a tower edge 38 of the top lip portion 32 to the top wall 26, while each bottom lip portion 34 is provided with a plurality of notches 40 extending from a top edge 41 downwardly to the bottom wall 28. The subframe assembly 22 further includes a plurality of laterally-extending structural cross members 42. In the illustrated example, each cross member 42 is provided a C-shaped cross-sectional configuration and includes a first end 44 and a second end 46.

In assembly, the first end 44 and the second end 46 of each cross member 42 is received within the frame rails 12 (FIGS. 5 and 6). Specifically, each end 44, 46 of each of the cross members 42 is received within the frame rails 12 by inserting the ends 44, 46 into the notches 36, 40. More specifically, each cross member 42 is provided with a sidewall 48, a top wall 50 extending orthogonally from and integrally formed with the sidewall 48, and a bottom wall 52 extending orthogonally from and integrally formed with the sidewall 48, and juxtaposed across the sidewall 48 from the top wall 50. Each of the cross members 42 is received within the notches such that the top wall 50 and the bottom watt 52 abut or are in close proximity to the top wall 26 and the bottom watt 28 of each of the frame rails 12, while the ends 44 and 46 abut the outer watt 30 of each of the frame rails 12. Preferably, welds are placed between the top wall 50 and bottom wall 52 of the cross members 42 and the top wall 26 and the bottom watt 28 of the associated frame rails 12, as well as between the ends 44, 46 of the cross members 42 and the outer watts 30 of the frame rails 12, although other means of fastening the cross members 42 to the frame rails 12 may be utilized.

The notches 36 and 40 as provided in the frame rails 12 allows full-height cross members 42 or cross members 42 having a height that extends the full distance between the top wall 26 and the bottom wall 28 of the frame rails 12, to be utilized, thereby maximizing the structural reinforcement as provided by the cross members 42 to the overall slider assembly 10, as well as optimizing the weld surface area provided between the cross members 42 and the frame rails 12.

The present inventive slider assembly provides positive and precise positioning of structural cross members with respect to the associated slide members of a subframe assembly of a vehicle slider assembly, while simultaneously increasing the structural strength and rigidity thereof. Further, the slider assembly is more durable, efficient in use, economical to manufacture, is capable of a long operating life, and is particularly well adapted for the proposed use.

The invention claimed is:

1. A vehicle assembly comprising:
a pair of longitudinally extending rail members;
a slider assembly including a pair of longitudinally extending slider members slidably coupled to the rail members and each having a top wall, a bottom wall and at least one lip portion extending longitudinally along and inwardly from at least a select one of the top wall and the bottom wall, and at least one cross member extending between the slider members, wherein the at least one lip portion includes a notch that receives an end of the at least one cross member therein, such that the slider member is located proximate the top and bottom walls of each of the slider members;
a locking assembly operably coupled to the slider assembly and adapted to releasably engage the rail members, thereby selectively positioning the slider assembly with respect to the rail members; and
a suspension assembly operably coupled to the slider assembly, thereby supporting the slider assembly and the rail members above a ground surface.

2. The vehicle suspension assembly of claim 1, wherein the at one least lip portion includes an upper lip extending downwardly from the top wall of each of the slider members and a lower lip extending upwardly from the bottom wall of each of the slider members.

3. The vehicle suspension assembly of claim 2, wherein the at least one cross member includes a top wall and a bottom wall, and wherein the notch of each lip portion extends into each lip portion such that the top and bottoms walls of the at least one cross member abuts the top and bottom watts of each slider members, respectively.

4. The vehicle suspension assembly of claim 3, wherein the top wall and bottom watt of the at least one cross member are welded to the top and bottom watts of each of the slider members, respectively.

5. The vehicle suspension assembly of claim 1, wherein the at least one cross member includes a top wall and a bottom wall, and wherein the notch of each lip portion extends into each lip portion such that the top and bottoms watts of the at least one cross member abuts the top and bottom walls of each slider members, respectively.

6. The vehicle suspension assembly of claim 1, wherein the top wall and bottom wall of the at least one cross member are welded to the top and bottom walls of each of the slider members, respectively.

7. The vehicle suspension assembly of claim 1, wherein the slider members each comprise a substantially C-shaped cross-sectional configuration.

8. A slider assembly for adjustable supporting a vehicle frame assembly from a vehicle suspension assembly, the slider assembly comprising:
a pair of longitudinally extending slider members adapted to slidably couple to a pair of longitudinally extending rail members of a vehicle frame assembly, each slider member including a top wall, a bottom wall and at least one lip portion extending longitudinally along and inwardly from at least a select one of the top wall and the bottom wall, wherein the at least one Lip portion includes a notch extending therein; and
at least one cross member having a pair of opposite ends and extending between the slider members, wherein the ends of the at least one cross member are located within the at least one notch of the slider members, such that the cross member is located proximate the top and bottom walls of each of the slider members.

9. The slider assembly of claim 8, wherein the at Least one Lip portion includes an upper lip extending downwardly from the top wall of each of the slider members and a lower lip extending upwardly from the bottom wall of each of the slider members.

10. The slider assembly of claim 9, wherein the at Least one cross member includes a top wall and a bottom wall, and wherein the notch of each lip portion extends into each Lip portion such that the top and bottoms walls of the at least one cross member abuts the top and bottom walls of each slider members, respectively.

11. The slider assembly of claim 10, wherein the top wall and bottom wall of the at least one cross member are welded to the top and bottom walls of each of the slider members, respectively.

12. The slider assembly of claim 8, wherein the at least one cross member includes a top wall and a bottom wall, and wherein the notch of each lip portion extends into each lip portion such that the top and bottoms walls of the at least one cross member abuts the top and bottom walls of each slider members, respectively.

13. The slider assembly of claim 8, wherein the top wall and bottom wall of the at least one cross member are welded to the top and bottom walls of each of the slider members, respectively.

14. The slider assembly of claim 8, wherein the slider members each comprise a substantially C-shaped cross-sectional configuration.
